(19) United States
(12) Patent Application Publication
(10) Pub. No.: US 2022/0214700 A1
(43) Pub. Date: Jul. 7, 2022

(54) CONTROL METHOD AND DEVICE, AND STORAGE MEDIUM

(71) Applicant: SZ DJI TECHNOLOGY CO., LTD., Shenzhen (CN)

(72) Inventors: Xianghua JIA, Shenzhen (CN); Guang YAN, Shenzhen (CN); Lu WANG, Shenzhen (CN)

(73) Assignee: SZ DJI TECHNOLOGY CO., LTD., Shenzhen (CN)

(21) Appl. No.: 17/701,709

(22) Filed: Mar. 23, 2022

Related U.S. Application Data
(63) Continuation of application No. PCT/CN2019/114813, filed on Oct. 31, 2019.

(51) Int. Cl. G05D 1/10; G05D 1/00; G01C 21/20

(52) U.S. Cl. CPC G05D 1/101; B64C 39/024; G01C 21/20; G05D 1/0094

(57) ABSTRACT

A control method, a control device, and storage medium are provided. The control method may include: acquiring position information of a first reference point and a second reference point; acquiring a first direction corresponding to the first reference point and a second direction corresponding to the second reference point, where at least one of the first direction and the second direction is determined in response to a user's direction setting operation; and controlling the movable platform to perform a work task in a first work area based upon the position information of the first reference point and the second reference point, the first direction, and the second direction.

### CROSS-REFERENCE TO RELATED APPLICATION

The present application is a continuation of International Application No. PCT/CN2019/H4813, filed Oct. 31, 2019, the entire contents of which being incorporated herein by reference in its entirety.

### TECHNICAL FIELD

The present disclosure relates to the field of device control, and particularly relates to a control method and device, and a storage medium.

### BACKGROUND

With the continuous development of science and technology, various movable platforms have provided greater convenience for people's life, work, and entertainment. For example, in the application fields of agriculture, surveying and mapping, investigation, etc., the movable platform has been used to perform work tasks in the work area, such as spraying pesticides, collecting images, collecting soil samples, detecting fire sources, and the like. However, these work areas are often in irregular shape. Users need to manually control the movable platform to move in these irregular work areas after surveying the work areas, and then complete the operation in the work areas.

### SUMMARY

The present disclosure provides a control method, a control device, and a storage medium to improve the operation control of a movable platform.

According to a first aspect of the present disclosure, a control method for a movable platform is provided. The control method may include:

acquiring position information of a first reference point and a second reference point;

acquiring a first direction corresponding to the first reference point and a second direction corresponding to the second reference point, wherein at least one of the first direction and the second direction is determined in response to a direction setting operation of a user; and

controlling a movable platform to perform a work task in a first work area based upon the position information of the first reference point and the second reference point, the first direction, and the second direction,

wherein, the first work area is an area defined by a reference line connecting the first reference point and the second reference point, a reference line extending from the first reference point along the first direction, and a reference line extending from the second reference point extending along the second direction.

According a second aspect of the present disclosure, a control device for a movable platform is provided. The control device may include a memory having executable codes stored thereon, and one or more processors configured, individually or collectively, to execute the executable codes and, when executing the executable codes, to:

acquire position information of a first reference point and a second reference point;

acquire a first direction corresponding to the first reference point and a second direction corresponding to the second reference point, wherein at least one of the first direction and the second direction is determined in response to a direction setting operation of a user; and

control a movable platform to perform a work task in a first work area based upon the position information of the first reference point and the second reference point, the first direction, and the second direction,

wherein, the first work area is an area defined by a reference line connecting the first reference point and the second reference point, a reference line extending from the first reference point along the first direction, and a reference line extending from the second reference point extending along the second direction.

According to a third aspect of the present disclosure, a computer-readable storage medium having executable codes stored thereon is provided. The executable codes may be executed by a processor to cause the processor to implement the control method disclosed in the first aspect of the present disclosure.

By acquiring the position information of the first reference point and the second reference point, determining at least one of the first direction corresponding to the first reference point and the second direction corresponding to the second reference point based upon at least direction setting operation of the user, and controlling the movable platform to perform the work task in the first work area based upon the position information of the first reference point and the second reference point, the first direction, and the second direction, the user may set the reference direction corresponding to the reference point by operating a control terminal and flexibly plan the work area of the movable platform, which improves the operation convenience of controlling the movable platform and the operation efficiency.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic architecture diagram of an unmanned aerial vehicle system according to some embodiments of the present disclosure.

FIG. 2 illustrates a schematic structural diagram of an unmanned aerial vehicle according to some embodiments of the present disclosure.

FIG. 3 illustrates a schematic diagram of an operation planning according to some embodiments of the present disclosure.

FIG. 4 illustrates a schematic flowchart of a control method according to some embodiments of the present disclosure.

FIG. 5 illustrates a schematic diagram of a work area planning according to some embodiments of the present disclosure.

FIG. 6 illustrates a schematic diagram of generating a route in a work area according to some embodiments of the present disclosure.

FIG. 7 illustrates a schematic flowchart of a control method according to some embodiments of the present disclosure.

FIG. 8 illustrates a schematic diagram of a work area planning according to some embodiments of the present disclosure.

FIG. 9 illustrates a schematic structural diagram of a control device according to some embodiments of the present disclosure.

FIG. 10 illustrates a schematic structural diagram of an operation planning system for a movable platform according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, certain steps of the method may be performed in other orders or at the same time; some components/elements can also be disassembled, combined, or partially combined; therefore, the actual arrangement may be changed or modified according to actual conditions. In the case of no conflict, the components, elements, operations/steps, and other features disclosed in the embodiments may be combined with each other.

For large irregular plots, manual control of the movable platform is time-consuming and labor-intensive, and the operation is not convenient.

In order to improve the user experience of a movable platform, reduce the cumbersomeness of the user's manual control of the movable platform, and improve the convenience of using the movable platform, a user may define a route trajectory for the movable platform. The movable platform moves along the defined route and performs a work task. The movable platform may be an unmanned vehicle, an unmanned aerial vehicle, an unmanned ship, a robot, an amphibious or triphibious movable platform, etc. It may also be a movable platform with a certain manned function, for example, a car with automatic driving function or the like.

The route is not limited to a trajectory in airspace. In some embodiments, the route may also include a surface motion trajectory, an airspace motion trajectory, an underwater motion trajectory, etc. depending on the type of the movable platform.

When the movable platform moves along the route, the movable platform may perform a work task such as spraying pesticides, collecting images, collecting soil samples, detecting fire sources, and so on. Taking an unmanned aerial vehicle as an example, when the unmanned aerial vehicle operates in an agricultural field, the unmanned aerial vehicle may move along the route and spray pesticides on the land covered by the route or collect information of the vegetation growth.

The movable platform may receive instructions from a control terminal communicatively connected to the movable platform to perform the operation. The control terminal may be a mobile phone, a laptop computer, a remote control, a smart wearable device, a virtual reality (VR) control device, etc. The control terminal may detect an operation of a user through an interactive device. The interactive device may be an essential part of the control terminal and an interface for interacting with the user. The user may control the movable platform by operating the interactive device. When the user wants to control the movable platform, the user operates the interactive device of the control terminal, and the control terminal detects the user's operation through the interactive device. The interactive device may be, for example, one or more of the touch screen, keyboard, joystick, and wheel of the control terminal. At the same time, the touch screen may also display the operating parameters of the movable platform and the images captured by the movable platform.

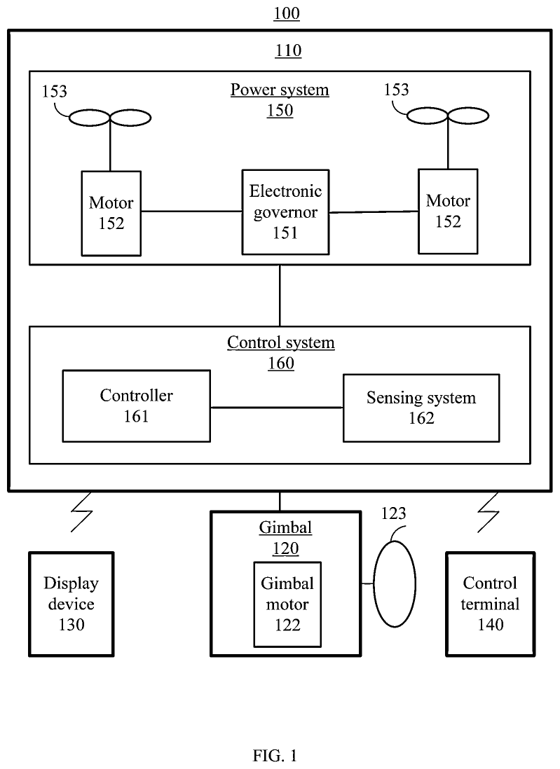

FIG. 1 illustrates a schematic architecture diagram of an unmanned aerial vehicle system 100 according to some embodiments of the present disclosure. As shown in FIG. 1, a rotary wing unmanned aerial vehicle is taken as an example for description.

The unmanned aerial vehicle system 100 may include an unmanned aerial vehicle 110, a display device 130, and a control terminal 140. In some embodiments, the unmanned aerial vehicle 110 may include a power system 150, a control system 160, a frame, and a gimbal 120 mounted on the frame. The unmanned aerial vehicle 110 may wirelessly communicate with the control terminal 140 and the display device 130. In other embodiments, the unmanned aerial vehicle may also be an unmanned vehicle or an unmanned ship.

The frame may include a body and a foot frame (also referred to as a landing frame or a landing gear). The body may include a center frame and one or more arms connected to the center frame, and the one or more arms extend radially from the center frame. The foot frame is connected to the body and is used to support the unmanned aerial vehicle 110 when it is landed.

The power system 150 may include one or more electronic governors 151, one or more propellers 153, and one or more motors 152 corresponding to the one or more propellers 153. The motor 152 is connected between the electronic governor 151 and the propeller 153, and the motor 152 and the propeller 153 are arranged on the arm of the unmanned aerial vehicle 110. The electronic governor 151 is used to receive a driving signal generated by the control system 160 and provide a driving current to the motor 152 according to the driving signal to control the rotation speed of the motor 152. It should be noted that one electronic governor 151 may correspond to multiple motors 152, or multiple electronic governors 151 may correspond to one motor 152. The motor 152 is configured to drive the propeller to rotate, thereby providing power for the flight of the unmanned aerial vehicle 110, and the power enables the unmanned aerial vehicle 110 to achieve one or more degrees of freedom of movement. In some embodiments, the unmanned aerial vehicle 110 may rotate about one or more rotation axes. For example, the rotation axis may include a roll axis (Roll), a yaw axis (Yaw), and a pitch axis (Pitch). It should be understood that the motor 152 may be a direct current (DC) motor or an alternating current (AC) motor. In addition, the motor 152 may be a brushless motor or a brushed motor.

The control system 160 may include a controller 161 and a sensing system 162. The sensing system 162 is configured to measure the attitude information of the unmanned aerial vehicle, that is, the position information and state information of the unmanned aerial vehicle 110 in space, such as three-dimensional position, three-dimensional angle, three-dimensional velocity, three-dimensional acceleration, and three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, or a barometer. For example, the global navigation satellite system may be a global positioning system (GPS). The controller 161 is configured to control the flight or operation of the unmanned aerial vehicle 110 and, for example, it may control the flight or operation of the unmanned aerial vehicle 110 according to the attitude information measured by the sensing system 162. In one embodiment, the controller 161 may control the unmanned aerial vehicle 110 according to pre-programmed program instructions; in another embodiment, the controller 161 may control the unmanned aerial vehicle 110 by responding to one or more control instructions from the control terminal 140.

The gimbal 120 may include a gimbal motor 122. The gimbal is utilized to carry a shooting device 123. The controller 161 may control the movement of the gimbal 120 through the gimbal motor 122. In some embodiments, the gimbal 120 may further include a gimbal controller for controlling the movement of the gimbal 120 by controlling the gimbal motor 122. It should be understood that the gimbal 120 may be independent of the unmanned aerial vehicle 110 or may be a part of the unmanned aerial vehicle 110. The gimbal motor 122 may be a DC motor or an AC motor. In addition, the gimbal motor 122 may be a brushless motor or a brushed motor. In some embodiments, the gimbal may be located on the top of the unmanned aerial vehicle. In other embodiments, the gimbal may be located at the bottom of the unmanned aerial vehicle.

The shooting device 123 may be, for example, a device for capturing images, such as a camera or a video camera, and the shooting device 123 may communicate with the flight controller and capture images under the control of the flight controller. In some embodiments, the shooting device 123 at least includes a photosensitive element, and the photosensitive element may be, for example, a complementary metal oxide semiconductor (CMOS) sensor or a charge-coupled device (CCD) sensor. It can be understood that the shooting device 123 may be directly fixed to the unmanned aerial vehicle 110, so that the gimbal 120 may be absent.

The display device 130 may be located on the ground, configured to communicate with the unmanned aerial vehicle 110 in a wireless manner and to display the attitude information of the unmanned aerial vehicle 110. In addition, an image captured by the shooting device may also be displayed on the display device 130. It can be understood that the display device 130 may be an independent device or may be integrated with the control terminal 140.

The control terminal 140 may be located on the ground in the unmanned aerial vehicle system 100 and may communicate with the unmanned aerial vehicle 110 in a wireless manner for remote control of the unmanned aerial vehicle 110.

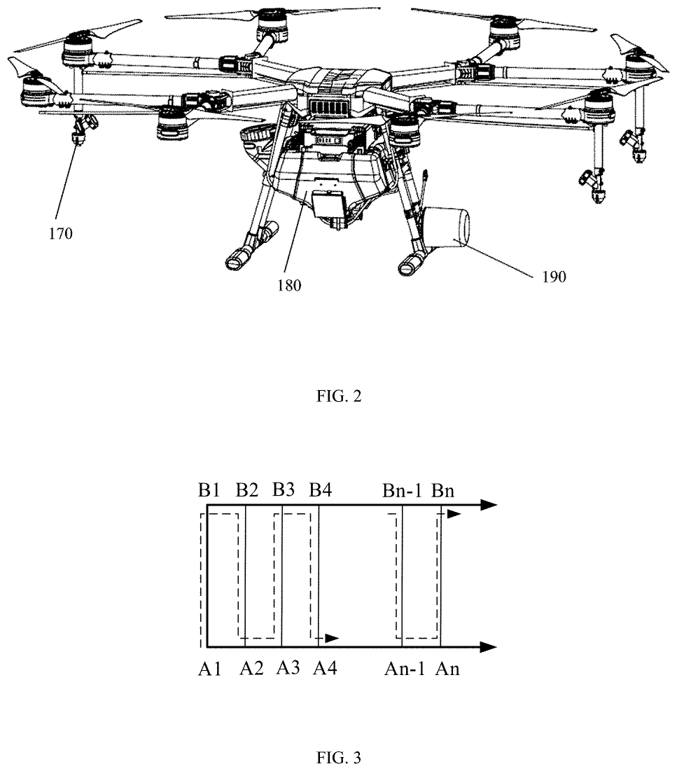

Taking the unmanned aerial vehicle as an agricultural unmanned aerial vehicle as an example, as shown in FIG. 2, which illustrates a schematic structural diagram of an unmanned aerial vehicle according to some embodiments of the present disclosure, a liquid storage tank 180 is provided between the foot frames of the unmanned aerial vehicle, and the liquid storage tank 180 is used to store liquid medicine or water. A spray head 170 is provided at the end of the arm. The liquid in the liquid storage tank 180 is pumped into the spray head 170 by a pump and is sprayed out by the spray head 170.

In addition, a continuous wave radar 190 may be mounted on the foot frame. In some embodiments, the continuous wave radar 190 may be a rotating continuous wave radar. The continuous wave radar 190 may be used for ranging, but is not limited to ranging. The agricultural unmanned aerial vehicle may include two or more foot frames, and the continuous wave radar 190 is mounted on one of the foot frames.

It should be understood that the naming of each component of the unmanned aerial vehicle system is only for identification purposes and should not be understood as a limitation to the embodiments of the present disclosure. The following embodiments of the present disclosure may be applied to the above unmanned aerial vehicle but may also be applied to other movable platforms.

FIG. 3 illustrates a schematic diagram of an operation planning according to some embodiments of the present disclosure. As shown in FIG. 3, which specifically shows a route planning in a rectangular operation plot, a user may first mark the position coordinates of point A1 and point B1, where point A1 is one corner point of the rectangular plot, and point B1 is another corner point of the rectangular plot, and then determine point A2 based upon the position of point A1 and an operation spacing, and point B2 based upon the position of point B1 and the operation spacing. Point A3 is determined based upon to the position of point A2 and the operation spacing, and point B3 is determined based upon the position of point B2 and the operation spacing, and so on, point An is determined based upon the position of point An-1 and the operation spacing, and point Bn is determined based upon the position of point Bn-1 and the operation spacing, and the position coordinates of point An and point Bn are determined accordingly.

Further, the planned route may include the connection between point A1 and point B1, the connection between point A2 and point B2, . . . the connection between point An and point Bn. Each of the connecting lines is parallel to each other. As shown by the dotted line in FIG. 3, when a movable platform performs a flight mission, it may take off from point A1 and passes through point B1, point B2, point A2, point A3, point B3, point B4, point A4 . . . point Bn-1, point An-1, point An, and point Bn.

When the movable platform flies along the above route, its trajectory is in a reciprocating “S” shape. In addition, the movable platform has a certain operating radius. With the movement of the movable platform, its operated area gradually covers the entire rectangular operation plot.

Thus, in the case of rectangular operation plot, by marking the initial points A1 and B1, the route covering the rectangular plot may be generated, which improves the convenience of the movable platform in the regular rectangular plot to a certain extent.

However, in the real world, the work area may present a variety of possible shapes. The user may determine the largest inscribed rectangular area in these irregular areas and plan the route for the movable platform to operate automatically within the inscribed rectangular area through the above scheme. Then, the user may manually control the movable platform to work on the rest irregular areas other than the inscribed rectangular area.

For example, in a triangular area, an inscribed rectangular area with the largest area is first determined, and then a route for the movable platform to operate automatically is planed through the above scheme. However, the small area in the corresponding triangular area other than the inscribed rectangular area, because it contains the edges and corners of the original triangular area, is not convenient to be described by a rectangular area, and it is not convenient to plan a route that may allow the movable platform to operate automatically. The user has to manually control the operation of the movable platform.

It is worth noting that in application scenarios where there are many irregular work areas, manual operations are time-consuming and labor-intensive.

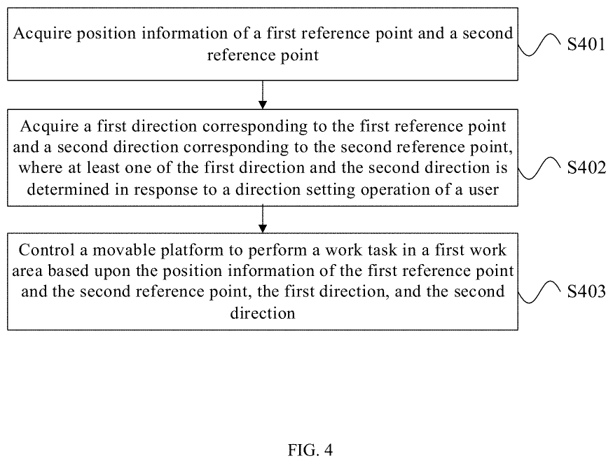

Therefore, the present disclosure provides a control method to improve the convenience of operation of the movable platform. FIG. 4 illustrates a schematic flowchart of a control method according to some embodiments of the present disclosure. As shown in FIG. 4, the control method may include steps S401-S403.

Step S401 may include acquiring position information of a first reference point and a second reference point.

In some embodiments, the position information of at least two reference waypoints may be acquired, and the at least two reference waypoints are respectively located at different boundaries of a target work area. For example, if the target work area is trapezoidal, the first reference point and the second reference point may be corner points located at the bottom side of the trapezoid, respectively.

In some embodiments, at least one of the position information of the first reference point and the position information of the second reference point is determined based upon the collected position information of the movable platform.

In some embodiments, acquiring position information of the first reference point and the second reference point may include: in response to a first position setting operation of a user, using current position information of the movable platform as the position information of the first reference point; and, in response to a second position setting operation of the user, using current position information of the movable platform as the position information of the second reference point.

In one embodiment, the process of the movable platform reaching the reference point may be controlled by the user. The user controls the movable platform to move to the reference point, and then executes the position setting operation.

In another embodiment, the movable platform may identify the reference point based upon a set reference point recognition rule and move to the reference point. The reference point may be correspondingly provided with an identifier, such as a ground cross identification, a flagpole identification, etc., and the movable platform may recognize the position of the identifier and sends an inquiry message to the user whether to perform position setting. Further, after receiving the inquiry message, the user may perform the position setting operation.

The position setting operation may be pressing a position setting confirmation key of a terminal device communicatively connected with the movable platform. Then, a corresponding instruction is generated based on the confirmation key. It may also be that the user issues a voice instruction for instructing to collect the coordinates of the current position of the movable platform. It may also be that the user issues a gesture instruction for instructing to collect the coordinates of the current position of the movable platform.

These instructions may be responded to by the movable platform, or by a control device communicatively connected with the movable platform, and the current position information of the movable platform is used as the position information of the reference point.

Taking an unmanned aerial vehicle as an example, the user may control the unmanned aerial vehicle to fly to a reference point and control the unmanned aerial vehicle to hover, and in response to the position setting operation, the current position information of the unmanned aerial vehicle is used as the position information of the reference point.

In some embodiments, at least one of the position information of the first reference point and the position information of the second reference position point is determined by detecting a third position setting operation of a user on a digital map displayed on a terminal device communicatively connected to the movable platform.

In one embodiment, the position setting operation may include the user selecting a point on the digital map.

Accordingly, acquiring position information of the first reference point and the second reference point may include: in response to a third position setting operation of the user, determining the position information of the first reference point based upon the position coordinates of a point selected by the user on the digital map; and in response to a fourth position setting operation of the user, determining the position information of the second reference point based upon the position coordinates of a point selected by the user on the digital map.

In one embodiment, the movable platform is an aircraft, the position information of the reference point may be determined based upon the position coordinates and the range height of the selected point on the digital map.

The selected point on the digital map may include two-dimensional coordinates, such as latitude and longitude coordinates. On the basis of the two-dimensional coordinates, a three-dimensional coordinate is further determined based upon the range height as the position information of the reference point.

In some embodiments, at least one of the position information of the first reference point and the position information of the second reference point is determined by the collected position information of a terminal device communicatively connected with the movable platform.

In certain embodiments, acquiring position information of the first reference point and the second reference point may include: in response to a fifth position setting operation of a user, using current position information of the terminal device as the position information of the first reference point; and in response to a sixth position setting operation of the user, using current position information of the terminal device as the position information of the second reference point.

In one embodiment, the user may bring the terminal device to the first reference point to perform the fifth position setting operation and then the user may bring the terminal device to the second reference point to perform the sixth position setting operation.

Step S402 may include acquiring a first direction corresponding to the first reference point and a second direction corresponding to the second reference point, where at least one of the first direction and the second direction is determined in response to a direction setting operation of a user.

In some embodiments, the position information of at least two reference waypoints may be acquired, and the at least two reference waypoints are respectively located at different boundaries of a target work area. For example, the first reference point is located at a first boundary, and the first direction is the extension direction of the first boundary; the second reference point is located at a second boundary, and the second direction is the extension direction of the second boundary.

For example, in one embodiment, the target work area is trapezoidal, the first reference point and the second reference point may be corner points located at the bottom side of the trapezoid, respectively. The first reference point is located at a first waistline of the trapezoid, and the second reference point is located at a second waistline of the trapezoid. The first direction is the extension direction of the first waistline, and the second direction is the extension direction of the second waistline.

For example, in another embodiment, the target work area is triangular, the first reference point and the second reference point may be corner points connected by a first side of the triangle. The first reference point is located on a second side of the triangle, and the second reference point is located on a third side of the triangle. The first direction is the extension direction of the second side, and the second direction is the extension direction of the third side.

It is worth noting that the above description of the shape of the target work area is only an illustrative example for easy understanding and is not used to limit the present disclosure. For example, the shape of the target work area may also be a parallelogram or any quadrilateral. For a complex shape, such as a pentagon, a hexagon, a dodecagon, or other complex shapes, corresponding processing may be performed by determining multiple reference points and corresponding directions. Alternatively, the complex polygon may be divided into multiple simple triangles or quadrilaterals.

The direction may be identified by vector information in a certain coordinate system. The coordinate system may be either the earth coordinate system or the site-centric coordinate system. The site-centric coordinate system is also called station-origin coordinates, or the east-north-up (ENU) coordinate system, which is a local Cartesian coordinates coordinate system.

In addition, the direction may be represented by an included angle of a certain fixed direction. For example, after acquiring the position information of the first reference point and the second reference point, the direction of a reference line connecting the first reference point and the second reference point may be determined, and the first direction corresponding to the first reference point may be represented by a first included angle with the reference line, and the second direction corresponding to the second reference point may be represented by a second included angle with the reference line.

In some embodiments, at least one of the first direction and the second direction is determined based upon a collected heading direction of the movable platform.

The heading direction of the movable platform may include a heading direction of a body of the movable platform or a heading direction of a shooting device of the movable platform. For example, the heading direction of the body of the movable platform is the nose direction of the movable platform.

It is worth noting that in some embodiments, the movement of the movable platform is in a “headless mode”, that is, when the movable platform moves in various directions, there is no need to adjust the attitude to make the nose face the direction of movement. Taking the scenario where the movable platform moves in any direction according to the joystick direction of a control terminal as an example, the current motion direction of the movable platform or the current joystick direction of the control terminal may be taken as the heading direction of the body.

In some embodiments, acquiring the first direction and the second direction may include: in response to a first direction setting operation of a user on a terminal device communicatively connected with the movable platform, collecting a heading direction of the movable platform, and taking the collected heading direction as the first direction; and in response to a second direction setting operation of the user on the terminal device communicatively connected with the movable platform, collecting the heading direction of the movable platform, and taking the collected heading direction as the second direction.

In one embodiment, the user may control the movable platform to reach the first reference point and collect the position coordinates of the first reference point through the first position setting operation. Then, the movable platform is controlled to rotate in situ, or move slightly, so that the heading direction of the movable platform is controlled to point to the extension direction of a boundary of the work area, and the first direction setting operation is performed to determine the first direction according to the heading direction. Further, operations similar to those of the first reference point and the first direction are performed at the second reference point, the position coordinates of the second reference point are acquired, and the second direction is determined.

In order to improve the convenience of direction setting, the movable platform may be equipped with a shooting device, and the control method may further include: displaying an image collected by the shooting device on the terminal device; and displaying a heading direction indicator for indicating the heading direction of the movable platform.

In this way, the user may observe the environment in which the movable platform is located through the image and determine whether the heading direction of the movable platform points to the extension direction of the boundary of the work area through the relationship between the characteristics of objects in the environment and the heading direction indicator.

Take a farmland work area as an example. The farmland is usually surrounded by roads, ridges, or rows of trees. Based on the imaging size of these objects in the image and their proportion in the imaging frame, the user may determine whether the heading direction of the movable platform points to the extension direction of the boundary of the work area. In addition, the heading direction indicator may assist the user in determination to a certain extent, which improves the convenience of setting such a direction.

In one embodiment, the line of view direction of the shooting device may be consistent with the heading direction, so the acquired image may be referred to as the first person view (FPV) of the movable platform. The center of the FPV image frame corresponds to the front view direction of the current shooting device. Since the direction corresponding to the center of the image is actually the heading direction of the movable platform, the heading direction indicator may be displayed in the center of the image. The heading direction indicator may be in the form of an arrow, an extension line, or other graphic patterns. In order to enhance the user's senses, the image may also be processed with a preset image processing template to correct the distortion of the image, or the visual effect of the central area may be enhanced by adjusting the contrast, adjusting the brightness, or other processing methods.

When the user sees that the heading direction indicator coincides with the scene in the extension direction of the boundary of the work area in the image, it may be considered that the heading direction of the movable platform is consistent with the extension direction of the boundary of the actual work area, and then a current heading direction of the movable platform is collected through the first direction setting operation, and the first direction is determined according to the collected heading direction. The setting operation corresponding to the second direction is similar to that of the first direction.

In some embodiments, at least one of the first direction and the second direction is determined by the collected orientation of a terminal device communicatively connected with the movable platform.

The terminal device may be configured with an electronic gyroscope to sense the orientation of the terminal device with respect to the earth coordinate system.

In certain embodiments, acquiring position information of the first reference point and the second reference point may include: in response to a fifth direction setting operation of a user, determining the first direction based upon a current orientation of the terminal device; and in response to a sixth direction setting operation of the user, determining the second direction based upon a current orientation of the terminal device.

In one embodiment, the user may move the terminal device to point to the extension direction of a boundary of the work area and perform the fifth direction setting operation. Then the user may move the terminal device to point to the extension direction of another boundary of the work area and perform the sixth direction setting operation.

For example, the user may bring the terminal device to the first reference point and collect the position coordinates of the first reference point. Then, the terminal device is controlled to rotate in place, or move slightly, so that the orientation of the terminal device points to the extension direction of a boundary of the work area, and the fifth direction setting operation is performed to determine the first direction based upon the orientation of the terminal device. Further, the user may carry the terminal device to the second reference point and perform operations similar to that of the first reference point and the first direction to acquire the position coordinates of the second reference point and to determine the second direction.

In some embodiments, at least one of the first direction and the second direction is determined by detecting a third direction setting operation of a user on a digital map displayed on a control terminal communicatively connected to the movable platform.

In certain embodiments, the control method may further include displaying a direction indicator corresponding to the at least one direction on the digital map. The third direction setting operation may include an operation for adjusting the direction of the direction indicator.

For example, a digital map of the work area may be displayed on the control terminal, and the identifier of the determined first reference point may be displayed, and an identification line from the first reference point as the starting point may be displayed for identifying the extension direction of the first direction. The user may drag the identification line on the display screen, lengthen or shorten the identification line, and/or rotate the identification line to make the identification line meet the requirements. Through the operation of clicking a confirmation key, the first direction may be determined according to the identification line.

In some embodiments, at least one of the first direction and the second direction is determined by a motion path of the movable platform.

Taking the first direction as an example, the user may control the movable platform to move along a boundary of the target work area, where the first reference point is located, from the first reference point. Then, the first direction may be determined according to the motion path of the movable platform as a point.

It is worth noting that the motion path of the movable platform under the control of the user may not be a straight line, which will bring uncertainty. In one embodiment, several reference points on the motion path may be selected, and the direction may be determined based upon the reference line between the several reference points.

Step S403 may include controlling a movable platform to perform a work task in a first work area based upon the position information of the first reference point and the second reference point, the first direction, and the second direction.

The first work area is an area defined by a reference line connecting the first reference point and the second reference point, a reference line extending from the first reference point along the first direction, and a reference line extending from the second reference point along the second direction.

The first work area may be a part of an area to be planned. Therefore, through the scheme disclosed above, multiple work areas may be determined from the area to be planned.

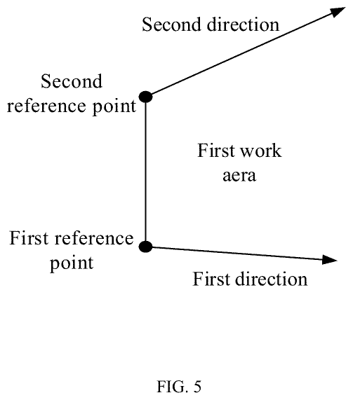

FIG. 5 illustrates a schematic diagram of a work area planning according to some embodiments of the present disclosure. As shown in FIG. 5, after determining the first reference point, the second reference point, the first direction, and the second direction, the work area of the movable platform is also determined, i.e., the area defined by the reference line between the first reference point and the second reference point, the reference line extending from the first reference point along the first direction, and the reference line extending from the second reference point along the second direction. The first direction and the second direction may be any direction to adapt to an irregular work area.

Thus, by acquiring the position information of the first reference point and the second reference point, determining at least one of the first direction corresponding to the first reference point and the second direction corresponding to the second reference point based on at least the user's direction setting operation, and controlling the movable platform to perform the work task in the first work area based upon the position information of the first reference point and the second reference point, the first direction, and the second direction, the user may set the reference direction corresponding to the reference point through the operation of the control terminal and flexibly plan the work area of the movable platform, which improves the operation convenience of controlling the movable platform and the operation efficiency.

In some embodiments, controlling the movable platform to perform the work task in the first work area based upon the position information of the first reference point and the second reference point, the first direction, and the second direction may include: planning a route based upon the position information of the first reference point and the second reference point, the first direction, and the second direction; and controlling the movable platform to perform the work task in the first work area based upon the planned route.

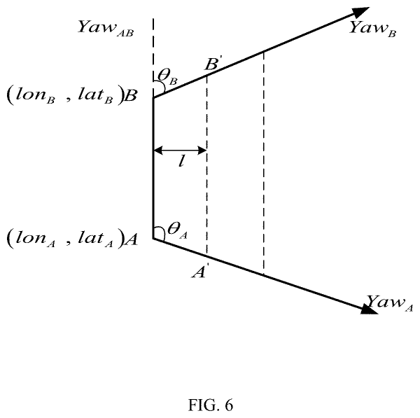

In other words, a route planning may be carried out in the first work area. FIG. 6 illustrates a schematic diagram of generating a route in a work area according to some embodiments of the present disclosure. As shown in FIG. 6, the longitude and latitude of the determined first reference point A are (lon_{A}, lat_{A}), the first reference direction, i.e., the first direction, (for example, the collected heading direction of the movable platform at point A) is Yaw_{A}, the longitude and latitude of the second reference point B are (lon_{B}, lat_{B}), and the second reference direction, i.e., the second direction, (for example, the collected heading direction of the movable platform at point B) is Yaw_{B}, the set operation spacing is l, the heading direction of the movable platform moving along the extension line of the reference line between point A and point B is Yaw_{AB}.

Then, the angle difference between the direction of the extension line of the reference line between point A and point B and the first reference direction may be calculated to be θ_{A}=(Yaw_{A}−Yaw_{AB}), and the angle difference between the direction of the extension line of the reference line between point A and point B and the second reference direction is θ_{B}=(Yaw_{B}−Yaw_{AB}), combined with the operation spacing l, the distance between the next waypoint of point A′ along the first reference direction and point A, l_{A-A′}, and the distance between the next waypoint of point B′ along the second reference direction and point B, l_{B-B′}, may be obtained according to the following formula:

l_{A-A′}=l/sin θ_{A}

l_{B-B′}=l/sin θ_{B}

Then based upon the latitude and longitude transformation formula and l_{A-A′}, the latitude and longitude coordinates of A′ may be obtained, and based upon the latitude and longitude transformation formula and l_{B-B′}, the latitude and longitude coordinates of B′ may be obtained. Accordingly, other waypoints may be derived by similar way from the above process and will not be repeated herein.

The determined waypoints are connected to obtain the route so that the route of the movable platform covers the first work area.

For example, the planned route is composed of multiple route units. The route unit may include a main route segment, and two end points of the main route segment are located on the reference line extending from the first reference point along the first direction and the reference line extending from the second reference point along the second direction, respectively. For example, the connection line of A′B′ is the main route segment.

The route unit may further include a secondary route segment connecting any two adjacent main route segments. The ends of the secondary route segment coincide with the ends of the two adjacent main route segments located on the same reference line. For example, the connection line of BB′ is the secondary route segment.

The main route segment is parallel to the reference line connecting the first reference point and the second reference point. The position of the end point of the main route segment is determined based upon the set operation spacing. For example, the connection line of A′B′ is parallel to the connection line of AB, and the interval between the two is the operation spacing l.

In one embodiment, the operation spacing may be determined based upon a user's operation spacing setting operation. In another embodiment, the operation spacing may also be acquired from the network platform in the related field. In yet another embodiment, the operation spacing may be set according to the type of operation, for example, the planting interval of vegetation in the agricultural field. In still yet another embodiment, the operation spacing may be set based upon the operating radius of the movable platform.

It is worth noting that the above scheme is only an illustrative scheme for the route planning method. In some embodiments, according to actual operation requirements, a spiral route, or a grid route, etc., may be planned in the area defined by the reference line between the first reference point and the second reference point, the reference line extending from the first reference point along the first reference direction, and the reference line extending from the second reference point along the second reference direction.

In the above embodiments, the first work area is an area defined by the reference line between the first reference point and the second reference point, the reference line extending from the first reference point along the first reference direction (i.e., the first direction), and the reference line extending from the second reference point along the second reference direction (i.e., the second direction). Without more restrictions, it will be surrounded by three sides.

If the reference line extending from the first reference point along the first reference direction intersects the reference line extending from the second reference point along the second reference direction at a distance, the first work area will be a triangular shape surrounded by three sides.

If the reference line extending from the first reference point along the first reference direction is parallel to the reference line extending from the second reference point along the second reference direction, or the distance between the two reference lines is farther away along extension directions of the first and second reference directions, then the first work area is open, and the route of the movable platform may extend indefinitely in this area, of course, till the end of the actual operation plot.

When displaying the route to the user, a preset number of route units may be displayed first, and more route units may be further displayed after the movable platform passes these route units.

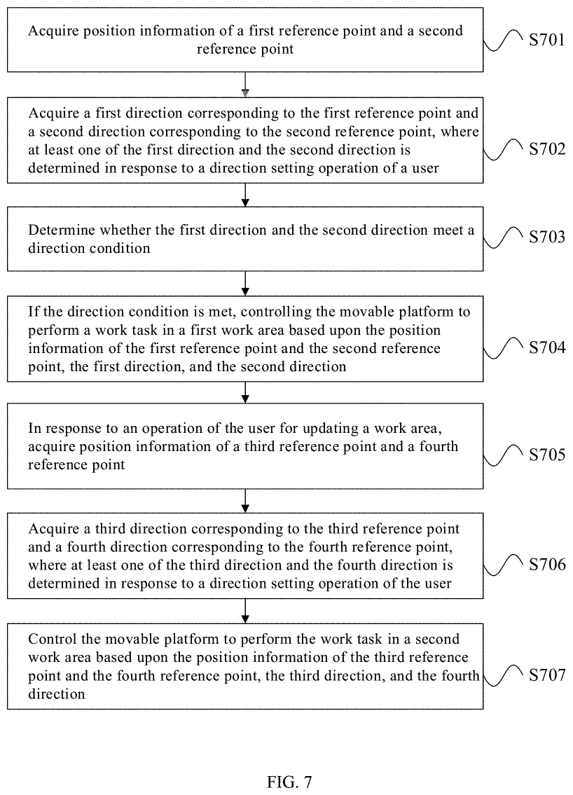

FIG. 7 illustrates a schematic flowchart of another control method according to some embodiments of the present disclosure. As shown in FIG. 7, the control method may include steps S701-S707.

Step S701 may include acquiring position information of a first reference point and a second reference point.

Step S702 may include acquiring a first direction corresponding to the first reference point and a second direction corresponding to the second reference point, where at least one of the first direction and the second direction is determined in response to a direction setting operation of a user.

Step S703 may include determining whether the first direction and the second direction meet a direction condition.

In some embodiments, the direction condition may include that the first direction and the second direction both point to the same side of a reference line of the first reference point and the second reference point, and an included angle between the first direction and the second direction is greater than 0° and less than 180°.

In some embodiments, the direction condition may include that the first direction and the second direction both point to the same side of a reference line of the first reference point and the second reference point, an included angle between the extension direction of the reference line of the first reference point and the second reference point and the first direction is greater than 0° and less than 180°, and an included angle between the extension direction of the reference line of the first reference point and the second reference point and the second direction is greater than 0° and less than 180°.

In some embodiments, the direction condition may include that an included angle between the first direction and a normal direction of the reference line of the first reference point and the second reference point and an included angle between the second direction and the same normal direction are both less than 90 degrees.

In other embodiments, the direction condition may be set according to the actual operating capacity of the movable platform, for example, limited by the minimum turning angle of the movable platform. For example, the minimum turning angle of the movable platform is 30 degrees. If the included angle between the extension direction of the reference line of the first reference point and the second reference point and the first direction is 170°, there will be acute turning angles of 10° between multiple main routes and the secondary routes on the boundary corresponding to the first direction, resulting that the movable platform cannot perform the turning operation, thus the first direction setting is invalid.

Step S704 may include, if the direction condition is met, controlling the movable platform to perform a work task in a first work area based upon the position information of the first reference point and the second reference point, the first direction, and the second direction.

The first work area is an area defined by a reference line connecting the first reference point and the second reference point, a reference line extending from the first reference point along the first direction, and a reference line extending from the second reference point along the second direction.

In certain embodiments, by determining whether the first direction and the second direction meet the direction condition, the effectiveness of the execution of subsequent steps may be further ensured.

In order to facilitate the user to update the planned work area, the control method may further include the following steps.

Step S705 may include, in response to an operation of the user for updating a work area, acquiring position information of a third reference point and a fourth reference point.

The operation for updating the work area may occur after the movable platform completes the work task in the first work area. The operation may also occur in the process of performing the work task, and the operation of the movable platform may be interrupted in response to this operation.

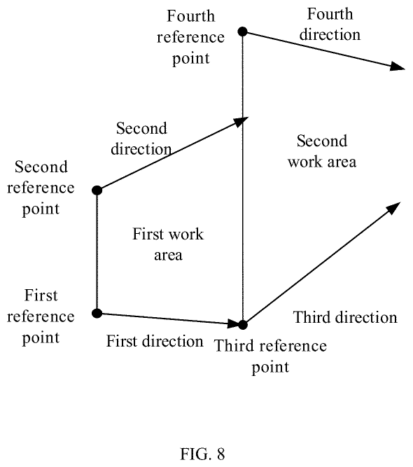

In some embodiments, the position information of any one of the third reference point and the fourth reference point may be determined according to a current position point of the movable platform when the task operation is interrupted. For example, the position information of the third reference point may be the current position of the movable platform when the task operation is interrupted. As shown in FIG. 8, the third reference point may also be a position at an end point corresponding to a route unit on the boundary (the reference line extending from the first reference point along the first direction, or the reference line extending from the second reference point along the second direction) where the movable platform is currently located when the task operation is interrupted.

In some embodiments, the position of the fourth reference point may be reset in response to a user's position setting operation.

In other embodiments, the position of the fourth reference point may be determined based upon collected position information of the movable platform, may be determined by collected position information of a terminal device communicatively connected with the movable platform, or may also be determined by detecting a user's position setting operation on a digital map displayed on the terminal device communicatively connected to the movable platform.

As shown in FIG. 8, which illustrates a schematic diagram of a work area planning according to some embodiments of the present disclosure, the position of the newly determined fourth reference point is far away from the originally planned first work area.

Step S706 may include acquiring a third direction corresponding to the third reference point and a fourth direction corresponding to the fourth reference point, where at least one of the third direction and the fourth direction is determined in response to a direction setting operation of the user.

In some embodiments, when the task operation is interrupted, a current position of the movable platform is on the reference line extending from the first reference point along the first direction, and the current position of the movable platform may be taken as the position of the third reference point. The third direction may be set to be consistent with the first direction. The third direction may also be reset according to the user's direction setting operation. As shown in FIG. 8, the third direction is inconsistent with the first direction.

The position of the fourth reference point may be reset in response to the user's position setting operation. As shown in FIG. 8, the fourth direction is a newly set direction.

The fourth direction corresponding to the fourth reference point may be determined based upon a collected heading direction of the movable platform. The heading direction of the movable platform may include a heading direction of the body of the movable platform or a heading direction of a shooting device of the movable platform. The heading direction of the body of the movable platform is the nose direction of the movable platform. In certain embodiments, the movable platform is equipped with a shooting device, and the control method may further include: displaying an image collected by the shooting device on a terminal device; and displaying a heading direction indicator for indicating the heading direction of the movable platform in the image.

In one embodiment, the fourth direction corresponding to the fourth reference point may be determined by a collected orientation of a terminal device communicatively connected with the movable platform; in another embodiment, it may be determined by detecting a user's direction setting operation on a digital map displayed on a control terminal communicatively connected with the movable platform; in yet another embodiment, the fourth direction may be determined by a motion path of the movable platform.

Step S707 may include controlling the movable platform to perform the work task in a second work area based upon the position information of the third reference point and the fourth reference point, the third direction, and the fourth direction.

The second work area is an area defined by a reference line extending from the third reference point along the third direction and a reference line extending from the fourth reference point along the fourth direction.

The second work area may be further defined by a reference line connecting the third reference point and the fourth reference point.

The method of planning a route in the second work area and further controlling the operation of the movable platform based on the planned route is similar to the method disclosed in the foregoing relevant embodiments, and the description will not be repeated herein for conciseness.

In response to the user's operation for updating the work area, based on the third reference point and the fourth reference point, the movable platform is controlled to operate in the second work area defined by the reference line extending from the third reference point along the third direction and the reference line extending from the fourth reference point along the fourth direction. In this way, it is convenient and flexible to carry out the work area planning of the movable platform.

In addition, in the planning of a complex-shaped work area, the first work area and the second work area may be planned in sequence.

In the above method embodiments, they are described in the form of steps for ease of description. It is worth noting that this is only an exemplary description, and the order of the description is not used to limit the execution order of the steps. For example, the first direction corresponding to the first reference point may be acquired first, and then the position information of the first reference point may be acquired, and then the second direction corresponding to the second reference point may be acquired, and then the position information of the second reference point may be acquired. For another example, each time the direction is acquired, a check step for determining whether the direction meets the direction condition may be executed.

In addition, the above embodiments do not limit a specific execution subject. The control methods disclosed above may be executed by the movable platform alone, or by the control terminal cooperating with the movable platform, or by the control terminal alone.

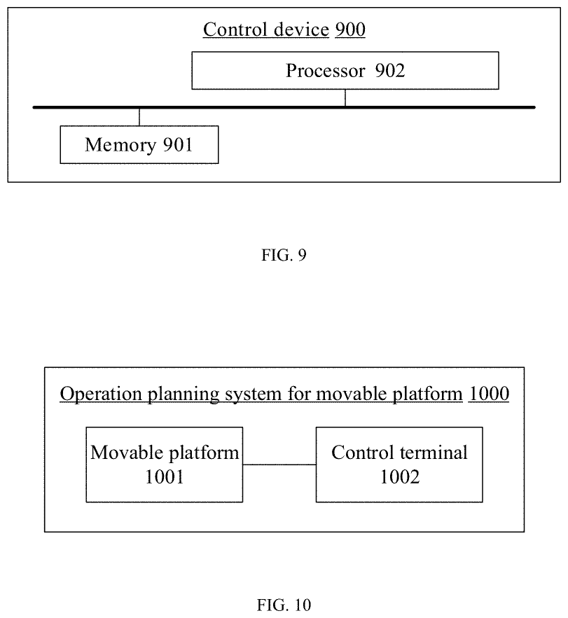

FIG. 9 illustrates a schematic structural diagram of a control device 900 according to some embodiments of the present disclosure. As shown in FIG. 9, the device 900 may include a memory 901 having stored executable codes thereon and one or more processors 902 operating individually or collectively. The memory 901 and the one or more processors 902 may be communicatively connected via a bus. The one or more processors 902 may be a central processing unit (CPU), and the one or more processors 902 may also be a general-purpose processor, a digital signal processor (DSP), an application specific integrated circuit (ASIC), a field-programmable gate array (FPGA) or other programmable logic device, a discrete gate or transistor logic device, a discrete hardware component, etc. The general-purpose processor may be a microprocessor or any conventional processor.

The one or more processors 902 are configured to execute the executable code stored in the memory 901 to implement:

acquiring position information of a first reference point and a second reference point;

acquiring a first direction corresponding to the first reference point and a second direction corresponding to the second reference point, wherein at least one of the first direction and the second direction is determined in response to a direction setting operation of a user; and

controlling a movable platform to perform a work task in a first work area based upon the position information of the first reference point and the second reference point, the first direction, and the second direction,

wherein, the first work area is an area defined by a reference line connecting the first reference point and the second reference point, a reference line extending from the first reference point along the first direction, and a reference line extending from the second reference point along the second direction.

Specifically, the position information of the first reference point and the second reference point may be determined based on the following implementation manners.

In some embodiments, the at least one of the position information of the first reference point and the position information of the second reference point is determined based upon a collected position information of the movable platform.

In certain embodiments, when the processors are configured to implement acquiring the position information of the first reference point and the second reference point, the processors are configured to implement:

in response to a first position setting operation of the user, taking current position information of the movable platform as the position information of the first reference point; and

in response to a second position setting operation of the user, taking current position information of the movable platform as the position information of the second reference point.

In some embodiments, the at least one of the position information of the first reference point and the position information of the second reference point is determined by a collected position information of a terminal device communicatively connected with the movable platform.

In some embodiments, the at least one of the position information of the first reference point and the location information of the second reference point is determined by detecting a third position setting operation of the user on a digital map displayed on a terminal device communicatively connected with the movable platform.

Specifically, the first direction and the second direction may be determined based on the following implementation manners.

In some embodiments, the at least one of the first direction and the second direction is determined based upon a collected heading direction of the movable platform.

In certain embodiments, the heading direction of the movable platform may include a heading direction of a body of the movable platform or a heading direction of a shooting device of the movable platform.

In certain embodiments, the heading direction of the body of the movable platform is a nose direction of the movable platform.

In certain embodiments, when the processors are configured to implement acquiring the first direction and the second direction, the processors are specifically configured to implement:

in response to a first direction setting operation of the user on a terminal device communicatively connected with the movable platform, collecting a heading direction of the movable platform, and taking the collected heading direction as the first direction; and

in response to a second direction setting operation of the user on the terminal device communicatively connected with the movable platform, collecting the heading direction of the movable platform, and taking the collected heading direction as the second direction.

In certain embodiments, the movable platform is equipped with a shooting device, and the processors are further configured to implement:

displaying an image collected by the shooting device on the terminal device;

display a heading direction indicator for indicating the heading direction of the movable platform in the image.

In some embodiments, the at least one of the first direction and the second direction is determined by a collected orientation of a terminal device communicatively connected with the movable platform.

In some embodiments, the at least one of the first direction and the second direction is determined by detecting a third direction setting operation of the user on a digital map displayed on a control terminal communicatively connected to the movable platform.

In certain embodiments, the processors are further configured to implement:

displaying a direction indicator corresponding to the at least one direction on the digital map.

The third direction setting operation may include an operation for adjusting a direction of the direction indicator.

In some embodiments, the at least one of the first direction and the second direction is determined by a motion path of the movable platform.

In some embodiments, when the processors are configured to implement controlling the movable platform to perform the work task in the first work area, the processors are specifically configured to implement:

planning a route in the first direction and the second direction based upon the position information of the first reference point and the second reference point; and

controlling the movable platform to perform the work task in the first work area based upon the movement of the movable platform along the route.

The planned route may include multiple route units. The route unit may include a main route segment, and two end points of the main route segment are located on the reference line extending from the first reference point along the first direction and the reference line extending from the second reference point along the second direction, respectively.

The route unit may further include a secondary route segment connecting any two adjacent main route segments. The ends of the secondary route segment coincide with the ends of the two adjacent main route segments located on the same reference line.

In certain embodiments, the main route segment is parallel to the reference line connecting the first reference point and the second reference point.

In certain embodiments, the position of the end point of the main route segment is determined based upon a set operation spacing.

In some embodiments, the processors are further configured to implement:

determining whether the first direction and the second direction meet a direction condition.

The controlling the movable platform to perform the work task in the first work area based upon the position information of the first reference point and the second reference point, the first direction, and the second direction may further include:

if the direction condition is met, controlling the movable platform to perform the work task in the first work area based upon the position information of the first reference point and the second reference point, the first direction, and the second direction.

In certain embodiments, the direction condition may include that the first direction and the second direction both point to the same side of the reference line of the first reference point and the second reference point, and an included angle between the first direction and the second direction is greater than 0° and less than 180°.

In some embodiments, the processor are further configured to implement:

in response to an operation of the user for updating the work area, acquiring position information of a third reference point and a fourth reference point;

acquiring a third direction corresponding to the third reference point and a fourth direction corresponding to the fourth reference point, wherein at least one of the third direction and the fourth direction is determined in response to a direction setting operation of the user; and

controlling the movable platform to perform the work task in a second work area based upon the position information of the third reference point and the fourth reference point, the third direction, and the fourth direction,

wherein, the second work area is an area defined by a reference line extending from the third reference point along the third direction and a reference line extending from the fourth reference point along the fourth direction.

In certain embodiments, the position information of at least one of the third reference point and the fourth reference point is determined based on a position where the movable platform is located when in response to the operation of the user for updating the work area.

FIG. 10 illustrates a schematic structural diagram of an operation planning system 1000 for a movable platform according to some embodiments of the present disclosure. As shown in FIG. 10, the operation planning system 1000 for a movable platform may include a movable platform 1001 and a control terminal 1002. The control terminal 1002 may adopt the structure of the control device shown in FIG. 9. Accordingly, the control terminal 1002 may execute the technical schemes of the control device according to the control method disclosed above, and the implementation principles and technical effects are similar, and will not be repeated herein for conciseness.

The present disclosure further provides a computer-readable storage medium on which a computer program is stored, and the computer program is executed by a processor to implement the steps of any one of the control methods disclosed above.

The computer-readable storage medium may be an internal storage unit of the movable platform, control device, and/or control terminal described in any of the foregoing embodiments, such as a hard disk or a memory of the movable platform, control device, and/or control terminal. The computer-readable storage medium may also be an external storage device of the movable platform, control device, and/or control terminal, such as a plug-in hard disk, a smart media card (SMC), and a secure digital (SD) card, a flash card, etc., equipped on the movable platform, control device, and/or control terminal.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer program, program instructions and/or program codes described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer program/program instructions/program codes for storage in a computer readable storage medium within the computing or processing device.

The computer program, program instructions and/or program codes for carrying out operations of the present disclosure may include machine language instructions and/or microcode, which may be compiled or interpreted from source code written in any combination of one or more programming languages, including assembly language, Basic, Fortran, Java, Python, R, C, C++, C#, or similar programming languages. the computer program/program instructions/program codes may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer program/program instructions/program codes by using information from the computer program/program instructions/program codes to configure or customize the electronic circuitry, in order to perform aspects of the present disclosure.

The computer program, program instructions and/or program codes that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. The computer program/program instructions/program codes may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer program, program instructions and/or program codes may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The program may be a collection of machine readable instructions and/or data that is stored in non-volatile storage medium and is used to create, manage, and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

Each part of the present disclosure may be implemented by hardware, software, firmware, or a combination thereof. In the above exemplary embodiments, multiple steps or methods may be implemented by hardware or software stored in a memory and executed by a suitable instruction execution system.

Unless otherwise defined, all technical and scientific terms used herein have the same meaning as commonly understood by those skilled in the technical field of the present disclosure. The terms used herein are only for the purpose of describing specific embodiments and are not intended to limit of the disclosure. As used in this disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items. Terms such as “connected” or “linked” are not limited to physical or mechanical connections, and may include electrical connections, whether direct or indirect. Phrases such as “a plurality of,” “multiple,” or “several ” mean two and more.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A control method, comprising:
acquiring position information of a first reference point and a second reference point;
acquiring a first direction corresponding to the first reference point and a second direction corresponding to the second reference point, wherein at least one of the first direction and the second direction is determined in response to a direction setting operation of a user; and
controlling a movable platform to perform a work task in a first work area based upon the position information of the first reference point and the second reference point, the first direction, and the second direction,
wherein, the first work area is an area defined by a reference line connecting the first reference point and the second reference point, a reference line extending from the first reference point along the first direction, and a reference line extending from the second reference point along the second direction.

2. The control method according to claim 1, wherein the at least one of the position information of the first reference point and the position information of the second reference point is determined based upon collected position information of the movable platform.

3. The control method according to claim 2, wherein the acquiring the position information of the first reference point and the second reference point comprises:
in response to a first position setting operation of the user, using current position information of the movable platform as the position information of the first reference point; and
in response to a second position setting operation of the user, using current position information of the movable platform as the position information of the second reference point.

4. The control method according to claim 1, wherein the at least one of the position information of the first reference point and the position information of the second reference point is determined based upon collected position information of a terminal device communicatively connected to the movable platform.

5. The control method according to claim 1, wherein the at least one of the position information of the first reference point and the position information of the second reference point is determined by detecting a third position setting operation of the user on a digital map displayed on a terminal device communicatively connected to the movable platform.

6. The control method according to claim 1, wherein the at least one of the first direction and the second direction is determined based upon a collected heading direction of the movable platform.

7. The control method according to claim 6, wherein the heading direction of the movable platform comprises a heading direction of a body of the movable platform or a heading direction of a shooting device of the movable platform.

8. The control method according to claim 7, wherein the heading direction of the body of the movable platform is a nose direction of the movable platform.

9. The control method according to claim 7, wherein the acquiring the first direction and the second direction comprises:
in response to a first direction setting operation of the user on a terminal device communicatively connected with the movable platform, collecting the heading direction of the movable platform, and using the collected heading direction as the first direction; and
in response to a second direction setting operation of the user on the terminal device communicatively connected with the movable platform, collecting the heading direction of the movable platform, and using the collected heading direction as the second direction.

10. The control method according to claim 9, further comprising:
displaying an image collected by the shooting device on the terminal device; and
displaying a heading direction indicator for indicating the heading direction of the movable platform in the image.

11. The control method according to claim 1, wherein the at least one of the first direction and the second direction is determined by a collected orientation of a terminal device communicatively connected to the movable platform.

12. The control method according to claim 1, wherein the at least one of the first direction and the second direction is determined by detecting a third direction setting operation of the user on a digital map displayed on a control terminal communicatively connected to the movable platform.

13. The control method according to claim 12, further comprising:
displaying a direction indicator corresponding to the at least one direction on the digital map,
wherein the third direction setting operation comprises an operation for adjusting a direction of the direction indicator.

14. The control method according to claim 1, wherein the at least one of the first direction and the second direction is determined by a motion path of the movable platform.

15. The control method according to claim 1, wherein, the controlling the movable platform to perform the work task in the first work area based upon the position information of the first reference point and the second reference point, the first direction, and the second direction, comprises:
planning a route in the first direction and the second direction based upon the position information of the first reference point and the second reference point; and
controlling the movable platform to perform the work task in the first work area based upon movement of the movable platform along the planned route.

16. The control method according to claim 15, wherein the planned route comprises a plurality of route units, wherein each of the route units comprises a main route segment, and two end points of the main route segment are located on the reference line extending from the first reference point along the first direction and the reference line extending from the second reference point along the second direction, respectively.

17. The control method according to claim 16, wherein the route unit further comprises a secondary route segment connecting any two adjacent main route segments, wherein ends of the secondary route segment coincide with ends of two adjacent main route segments located on the same reference line.

18. The control method according to claim 16, wherein the main route segment is parallel to the reference line connecting the first reference point and the second reference point.

19. The control method according to claim 16, wherein a position of an end point of the main route segment is determined based upon a set operation spacing.

20. The control method according to claim 1, further comprising:
determining whether the first direction and the second direction meet a direction condition,
wherein, the controlling the movable platform to perform the work task in the first work area based upon the position information of the first reference point and the second reference point, the first direction, and the second direction comprises:
in response to that the direction condition is met, controlling the movable platform to perform the work task in the first work area based upon the position information of the first reference point and the second reference point, the first direction, and the second direction.
